(19) United States
(12) Patent Application Publication
(10) Pub. No.: US 2022/0132820 A1
(43) Pub. Date: May 5, 2022

(54) Removable Fishing Lure Assembly

(71) Applicant: Brent Michael Willey, Anderson, SC (US)

(72) Inventor: Brent Michael Willey, Anderson, SC (US)

(21) Appl. No.: 17/518,892

(22) Filed: Nov. 4, 2021

Related U.S. Application Data
(60) Provisional application No. 63/109,432, filed on Nov. 4, 2020.

(51) Int. Cl. A01K 95/00; A01K 85/00

(52) U.S. Cl. CPC A01K 95/00; A01K 85/00

(57) ABSTRACT

The Removable Fishing Lure Assembly is comprised of a weighted body section, a removable retaining device, and an optional accessory attachment ring wherein the user can insert and remove a removable insert in the weighted body section. The weighted body section forms an internal void space through which a removable insert, such as a fishhook, slides in and out of the weighted body section. The weighted body section forms a geometry such that a removable retaining device is used to keep the removable insert in place while fishing. Once the removable insert is fully assembled inside the weighted body section, the weighted body section is kept in place by the retaining device due to the forces acting on both the weighted body section and the removable insert.

### STATEMENT REGARDING FEDERALLY SPONSORED RESEARCH OR DEVELOPMENT

Not applicable

### FIELD OF THE EMBODIMENTS

The field of the embodiments of the Removable Fishing Lure Assembly is generally fishing. More specifically, the field of the embodiments is the re-usability of a weighted body when the fishing hook is no longer viable.

### BACKGROUND OF THE EMBODIMENTS

A fishing lure is used to attract the attention of a fish. A fishing jig is a specific type of fishing lure that includes a weighted body (or jig head), a fishing hook, and artificial or natural bait to attract the fish. Most commercially available fishing jig heads have the weighted body section molded directly to the hook and thus the fishhooks are non-removable. Therefore, when the hook gets damaged, rusted or dull, both the weighted body and fishhook need to be discarded.

Additionally, many companies offer limited fishing hook size and jig head weight combinations. This limits a user's ability to adapt to the type of artificial or natural bait that can be used in conjunction with the jig head assembly.

One aspect of fishing is having the fishing lure get caught or snagged on objects beneath the water's surface. The lure either must be manually retrieved using specialized retrieval tools or cut from the fishing line and left in place.

### DESCRIPTION OF PRIOR ART

The prior art involves fishing lures. More specifically the prior art involves fishing lures that employ weighted jig heads used to present artificial rubber lures to fish.

### SUMMARY OF THE EMBODIMENTS

Embodiments of the Removable Fishing Lure Assembly are comprised of a weighted body section, a removable retaining device, and an optional accessory attachment device wherein the user can replace a removable insert in the weighted body section.

The purpose of one of the embodiments described herein is to allow a user to replace the fishing hook and continue to use the weighted body section thereby reducing waste and saving money; to allow a user to interchange fish hooks and weighted bodies, thereby giving greater flexibility to adapt to the type of artificial or natural bait being used in conjunction with the fishing lure assembly; to allow a user a better chance of retrieving the lure in the event the lure becomes stuck or snagged on objects in the water.

There has thus been outlined, rather broadly, the more important features of the embodiments of the Removable Fishing Lure Assembly in order that the detailed description thereof that follows may be better understood, and in order that the present contribution to the art may be better appreciated. There are, of course, additional features of the embodiments that will be described hereinafter and which will form the subject matter of the claims appended hereto.

In this respect, before explaining at least one embodiment of the embodiments in detail, it is to be understood that the embodiment is not limited in this application to the details of construction and to the arrangements of the components set forth in the following description or illustrated drawings. The embodiment or embodiments are capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be used as a basis for the designing of other structures, methods and systems for carrying out the several purposes of the embodiments. Additional benefits and advantages of the embodiments will become apparent in those skilled in the art to which the present embodiments related from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application, which is measured by the claims, nor is it intended to be limiting as to the scope of the embodiments in any way.

### BRIEF DESCRIPTION OF THE DRAWINGS

FIG. 1A is a perspective view of an embodiment of Removable Fishing Lure Assembly; FIG. 1B is a sectional view of an embodiment of Removable Fishing Lure Assembly.

FIG. 2 is a sectional view of an embodiment of Removable Fishing Lure Assembly.

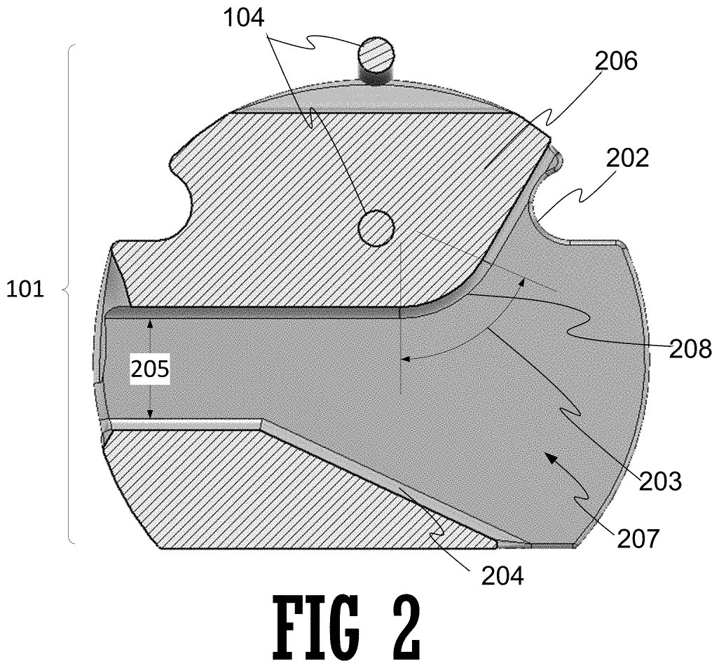

FIG. 3A is a side view of an embodiment of Removable Fishing Lure Assembly showing a hook being inserted into the embodiment; FIG. 3B is a side view of an embodiment of Removable Fishing Lure Assembly showing a hook being inserted into the embodiment through the rounded portion of the hook; FIG. 3C is a side view of an embodiment of Removable Fishing Lure Assembly showing a hook being inserted into the embodiment through the shank portion of the hook; FIG. 3D is a side view of an embodiment of Removable Fishing Lure Assembly showing a hook being inserted into the embodiment the eyelet portion of the hook; FIG. 3E is a close-up side view of an embodiment of Removable Fishing Lure Assembly showing a hook being inserted into the embodiment the eyelet portion of the hook and assembled to the jig head and the hook being placed in its final position.

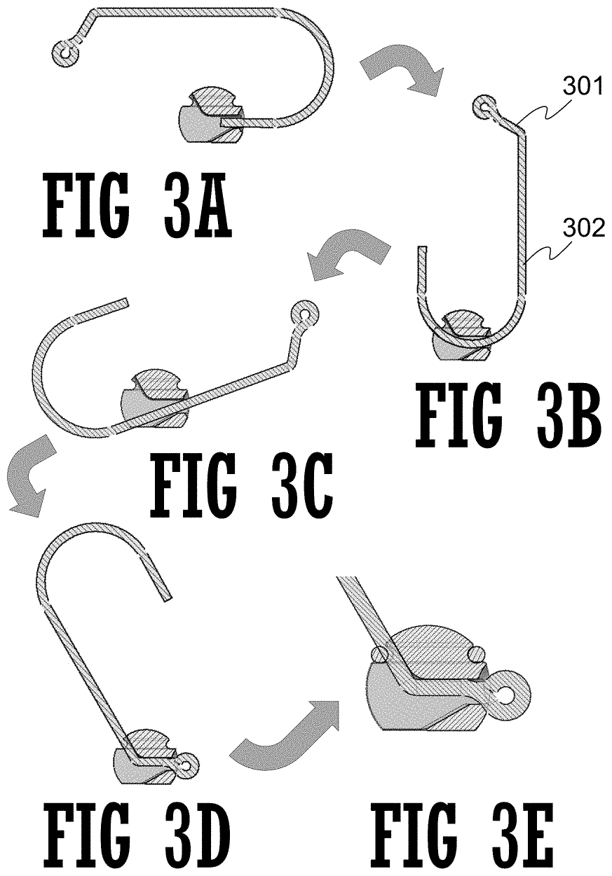

FIG. 4A is a cross-sectional view of an embodiment of the Removable Fishing Lure Assembly showing when the hook is at rest and no external forces are being applied; FIG. 4B is a cross-sectional view of an embodiment of Removable Fishing Lure Assembly showing when force is being applied to the hook eyelet, and this shows the extent of the movement typically seen when the hook is pulled away from the jig head; FIG. 4C is a cross-sectional view of an embodiment of Removable Fishing Lure Assembly showing the optional accessory attachment device at the top of the jig head and demonstrating the position of the hook when no external forces are applied to the hook.

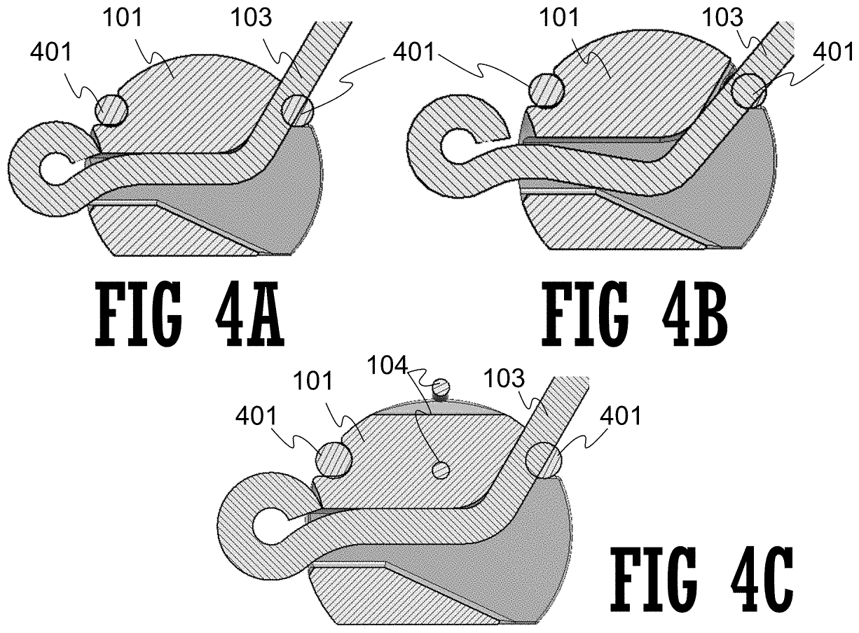

FIG. 5A is a top view of an embodiment of the Removable Fishing Lure Assembly showing the retaining device positioned below the eyelet and behind the shank; FIG. 5B is a sectional view of an embodiment of the Removable Fishing Lure Assembly showing the retaining device is positioned below the eyelet and behind the shank.

FIGS. 6A through 6D show an embodiment of the Removable Fishing Lure Assembly with the retaining device oriented over the center of the body. FIG. 6A is a perspective view of an embodiment of the Removable Fishing Lure; FIG. 6B is a side view of an embodiment of the Removable Fishing Lure Assembly showing how a hook can be attached to the embodiment. FIG. 6C is a sectional view of an embodiment of Removable Fishing Lure Assembly; FIG. 6D is a cross-sectional view of an embodiment of Removable Fishing Lure Assembly.

FIG. 7A is a perspective view of an embodiment of the Removable Fishing Lure Assembly; FIG. 7B is a perspective view of an embodiment of the Removable Fishing Lure Assembly showing the fishing hook and retaining device.

FIG. 8A is a top view of an embodiment of the Removable Fishing Lure Assembly; FIG. 8B is a front view of an embodiment of the Removable Fishing Lure Assembly; FIG. 8C is a bottom top view of an embodiment of the Removable Fishing Lure Assembly; FIG. 8D is side top view of an embodiment of the Removable Fishing Lure Assembly.

FIG. 9A is a front view of an embodiment of the Removable Fishing Lure Assembly; FIG. 9B is a sectional view of an embodiment of the Removable Fishing Lure Assembly.

FIG. 10A is a side view of an embodiment of the Removable Fishing Lure Assembly; FIG. 10B is a side view of an embodiment of the Removable Fishing Lure Assembly showing a hook attached to the embodiment; FIG. 10C is a side view of an embodiment of the Removable Fishing Lure Assembly showing a hook and an accessory attached to the embodiment.

### DETAILED DESCRIPTION OF THE PREFERRED EMBODIMENTS

The embodiments of the Removable Fishing Lure Assembly 100 are comprised of a weighted body section 101, a removable retaining device 401, and an optional accessory attachment device 104 wherein the user can insert and remove a removable or sacrificial insert 103 in the weighted body section.

The weighted body section 101 forms an internal void space 205 through which a removable insert 103, such as a fishhook 301, slides in and out of the weighted body section 101. The weighted body section 101 has a geometry such that a removable retaining device 401 is used to keep the removable insert 103 in place while fishing. Once the removable insert 103 is fully assembled inside the weighted body section 101, the weighted body section 101 is kept in place by the retaining device 401 due to the forces acting on both the weighted body section 101 and the removable insert 103.

The internal void space 207 is formed by an interior channel 205, and interior wall 204 and an interior radial wall 208 with an interior radial radius 203. The interior channel 205 has a diameter of between 0.10 mm and 3.0 mm. The interior radial opening 203 is formed by the interior wall 204 and the opposing interior wall 208. The angular opening of the interior radial opening 203 is between 20 degrees and 160 degrees. In one embodiment, the angular opening of the interior radial opening 203 is 60 degrees.

In an embodiment were the removable insert 103 is a fishhook 301, as the weighted body section 101 experiences forces pulling which pulls it down on the fishhook 301 shank 302, the geometry of the weighted body 101 causes the fishhook 301 to rotate and push the removable retaining device 401 against the weighted body 101. With sufficient force on the eye of the fishhook 301, the weighted body section 101 will slide down the hook shank, thereby giving another degree of rotation to free the fishing lure assembly 100 from underwater snags.

In one embodiment, the removable retaining device 401 is comprised of an 0-style ring, an E-style ring, a C-style ring, or a spiral style ring. The retaining device 401 can be either an internal or external style device. The retaining device 401 is comprised of elastomeric or metallic material. The removable retaining device 401 gives a user the ability to remove and replace a damaged or rusty fishhook 301, or change out the size of the fishhook 301, from the weighted body section 101.

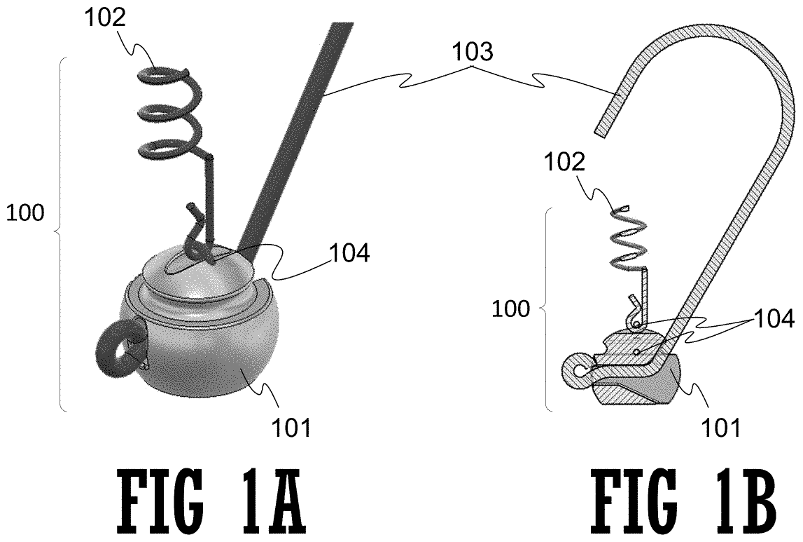

The optional accessory attachment device 104 acts as a location for holding accessories 102 on the fishing lure assembly 100. These accessories 102 include, but are not limited to, additional fishhooks, one or more keepers 1001, blades, rattles, scent media, trailer hooks, skirts, spinning appendages, oscillating appendages, and vibrating appendages. To be clear, all keepers 1001 are accessories 102, but not all accessories are keepers. For example, the accessories 102 shown on FIGS. 1A and 1B are keepers 1001. The one or more keepers 1001 is a means to attach a soft plastic lure to the Removable Fishing Lure Assembly 100. Keepers 1001 consist of wire or metal devices that are inserted into the soft plastic lure to mechanically hold the soft plastic lure to the Removable Fishing Lure Assembly 100. The optional accessory attachment device 104 allows the keeper to be attached to the Removable Fishing Lure Assembly 100.

In another embodiment, an integrally molded fixed keeper 1001 is permanently attached to the jig head and is constrained in all directions with no degree of freedom. This component will hold the soft plastic lure in place against the jig head and prevent the soft plastic lure from sliding down the shank of the hook when the user casts the lure, or in other situations where external forces try to separate the soft plastic lure from the jig head assembly.

The optional accessory attachment device 104 is integrally formed into the weighted body section 101. The process to integrally form the attachment device 104 includes, but is not limited to, being molded into the weighted body 101, being 3-D printed into the weighted body 101, being insert molded into the weighted body 101.

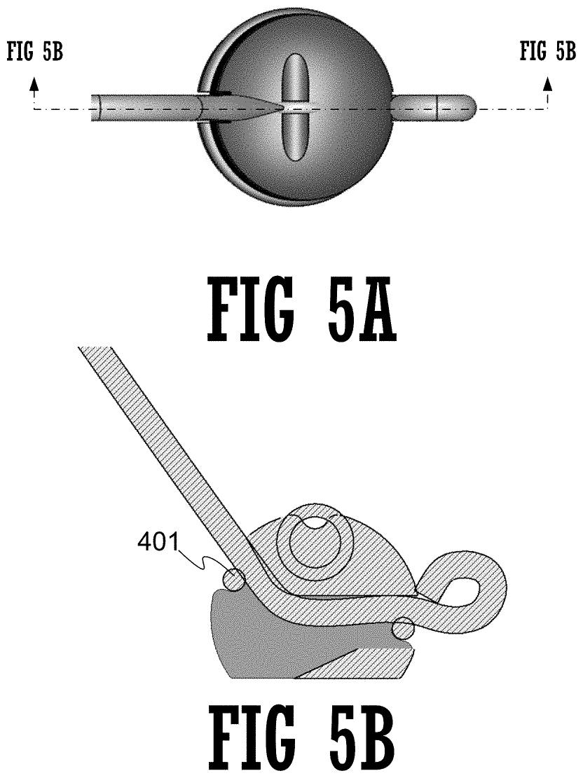

In another embodiment of the Removable Fishing Lure Assembly 100, the retaining device is located at an angle off and located across the horizontal axis of the Removable Fishing Lure Assembly 100. See FIGS. 5A and 5B. Because the retaining device 401 is positioned below the eyelet and behind the shank, any external forces will pull the weighted head down the shank of the hook, toward the hook point. The retaining device 401 will become a blocking device to the hooks natural course of movement. The retaining device 401 will act to limit the rotation of the hook and thus limiting the ability to slide down the hook. The accessory device is parallel with the hook rather than perpendicular in other embodiments. However, all embodiments can accommodate a parallel or perpendicular accessory device.

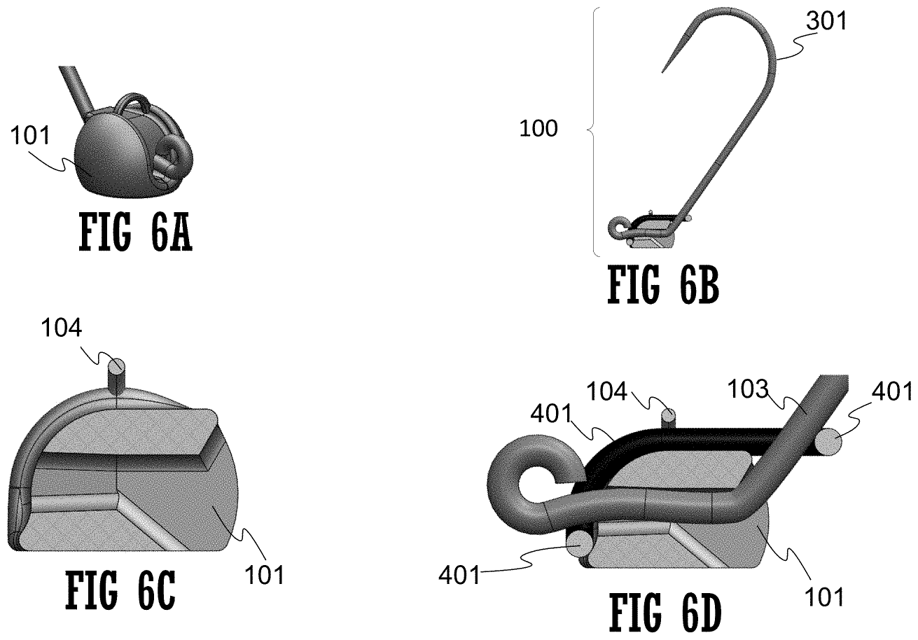

In another embodiment of the Removable Fishing Lure Assembly 100, the retaining device 401 lays over the center of the weighted body 101 and under the removable insert 103. See FIGS. 6A, 6B, 6C and 6D.

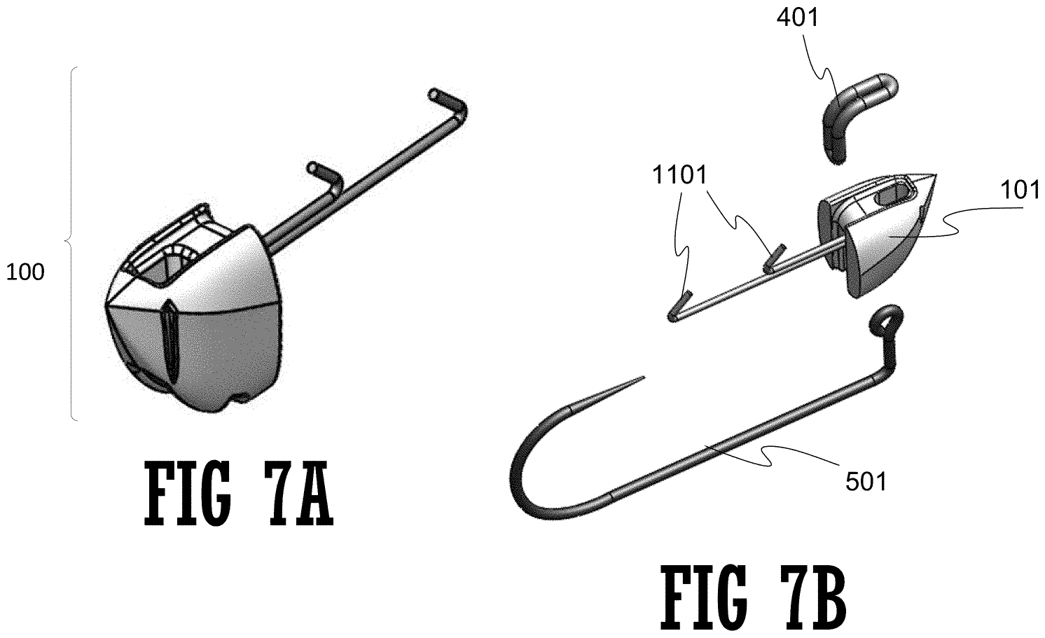

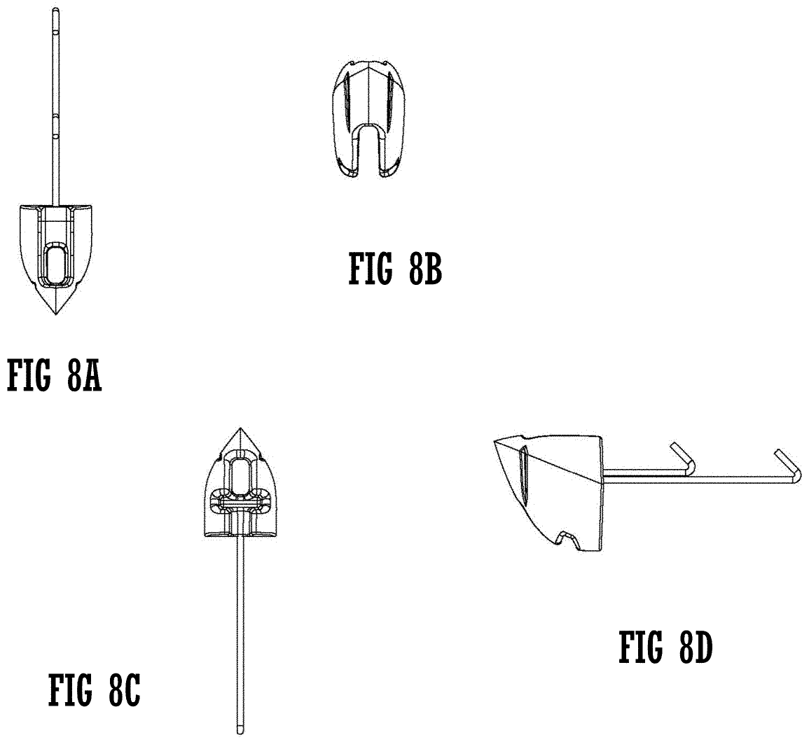

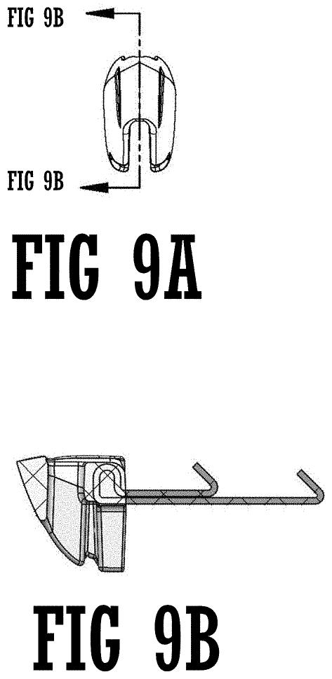

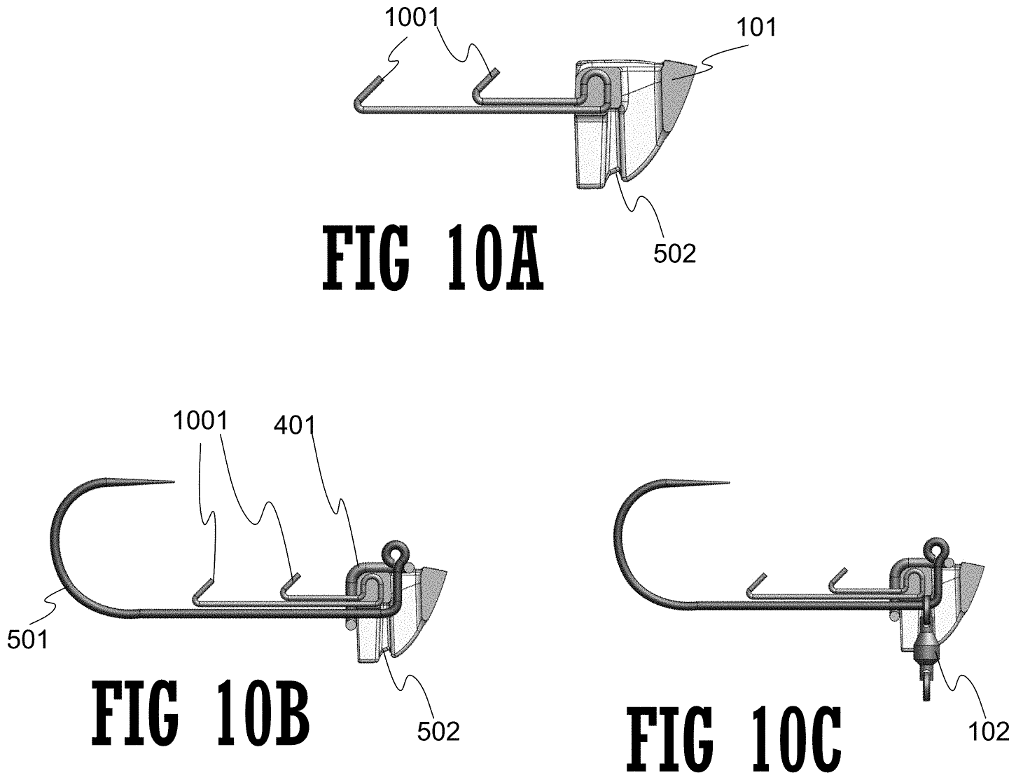

In another embodiment of the Removable Fishing Lure Assembly 100 the removable insert is a 90-degree bend fishhook 501. See FIGS. 7 through 10. This embodiment contains a keeper 1001 and contains a unique slot feature 502 in conjunction with the hook shank allows the user to further manipulate the weighted body 101 by adding accessories 102 on the underside of the body. See FIGS. 15A, 15B and 15C. The keeper 1001. The 90-degree hook 501 is held securely to the weighted body 101 by the retaining device 401 pulling the hook 501 into the rear section of the weighted body 101 which secures it in the X and Y direction, and the void is optimized to minimize movement in the Z direction. See FIG. 15B.

The embodiments of the removable head can be applied to any fishing lure that uses a weighted body attached to a hook. This includes lures such as spinnerbaits and buzz baits even though those types of baits are not commonly considered to be jig head baits.

What is claimed is:

1) A removable fishing lure assembly comprising a weighted section, a removable retaining device, and an optional accessory attachment device wherein the user capable of replacing a removable insert in the weighted body section.
